(19) United States
(12) Patent Application Publication
(10) Pub. No.: US 2024/0240071 A1
(43) Pub. Date: Jul. 18, 2024

(54) USE OF A COOLING COMPOSITION TO PROTECT A BATTERY

(71) Applicant: TOTALENERGIES ONETECH, Courtbevoie (FR)

(72) Inventors: Nicolas CHAMPAGNE, Solaize (FR); Jonathan RAISIN, Solaize (FR)

(73) Assignee: TOTALENERGIES ONETECH, Courbevoie (FR)

(21) Appl. No.: 18/564,922

(22) PCT Filed: Jun. 2, 2022
(86) PCT No.: PCT/EP2022/065141

§ 371 Date: Nov. 28, 2023

(30) Foreign Application Priority Data
Jun. 4, 2021 (FR) FR2105920

(51) Int. Cl. C09K 5/10; H01M 10/0525; H01M 10/613; H01M 10/625; H01M 10/6568

(52) U.S. Cl. CPC C09K 5/10; H01M 10/0525; H01M 10/613; H01M 10/625; H01M 10/6568; H01M 2220/20

(57) ABSTRACT

The present invention relates to a cooling composition for cooling a battery and protecting it against thermal runaway, the composition having a thermal conductivity lower than or equal to 120 mW·m−1·K−1. The invention also relates to a cooling device and to the use of the cooling composition to cool a battery and/or protect it against thermal runaway, the battery being implemented, for example, in a propulsion system of an electric or hybrid vehicle.

### TECHNICAL FIELD

The present invention relates to the field of compositions for cooling and protecting a battery, and in particular a lithium-ion battery, against the propagation of thermal runaway. The battery can be used in mobile or stationary applications. More particularly, the invention aims at cooling a propulsion system of an electric or hybrid vehicle, and more particularly at cooling the battery and optionally the power electronic systems of an electric or hybrid vehicle. More particularly, the invention aims at proposing a cooling composition compatible with the use thereof in a battery and optionally in power electronic systems.

### PRIOR ART

A battery is a system for producing electricity wherein chemical energy is converted into electrical energy. The chemical energy consists of electrochemically active compounds deposited on at least one face of electrodes arranged in the electrochemical generator. The electrical energy is produced by electrochemical reactions during a discharge of the electrochemical cell.

A battery comprises a plurality of electrochemical cells. A lithium-ion electrochemical cell is based on the principle of reversible insertion of lithium into a host structure, in an electrochemically active way.

In the field of electrochemical cells such as lithium-ion cells, the temperature of the cells has to be managed in order to maintain the temperature within an appropriate range of the cell.

Lithium-ion batteries are generally used at temperatures ranging from −40° C. to +70° C. In case of runaway, some cells can reach temperatures of the order of 400 to 800° C.

Batteries are commonly used in mobile or stationary applications.

Stationary applications include storage batteries, e.g. solar storage batteries.

Mobile applications include automotive applications. The evolution of international standards for the reduction of CO2 emissions, but also for the reduction of energy consumption, pushes car manufacturers to propose alternative solutions to internal combustion engines.

One of the solutions identified by car manufacturers is to replace internal combustion engines with electric motors. Research to reduce CO₂ emissions has thus led a number of automotive companies to develop electric vehicles.

“Electric vehicle” as defined by the present invention refers to a vehicle comprising an electric motor as the only means of propulsion, whereas a hybrid vehicle comprises an internal combustion engine and an electric motor as combined means of propulsion.

“Propulsion system” as defined by the present invention, refers to a system comprising the mechanical parts required for the propulsion of an electric vehicle. The propulsion system thereby encompasses more particularly an electric motor comprising the rotor-stator assembly of power electronic systems (dedicated to speed regulation), a transmission, and a battery. The battery as such usually consists of a set of electric accumulators, called cells.

In general, in electric or hybrid vehicles, it is necessary to use compositions so as to meet the lubrication and/or cooling requirements of the different parts of the aforementioned propulsion system.

More particularly, electric propulsion systems generate heat during operation thereof, via the electric motor, the power electronic systems and the batteries. Since the amount of heat generated is greater than the amount of heat normally dissipated into the environment, it is required to provide a cooling of the engine, the power electronic systems and the batteries. In general, cooling is performed on a plurality of heat-generating parts of the propulsion system and/or heat-sensitive parts of said system, in particular power electronic systems and batteries, so as to prevent dangerous temperatures from being reached.

Conventionally, it is known how to cool electric motors by air or water, optionally combined with glycol. However, with the emergence of increasingly smaller engines with increasingly higher power, such cooling methods are no longer sufficient. In addition, the heat that a battery can generate, in particular during a rapid charge, cannot be extracted by the methods conventionally used without reaching temperatures that damage the battery (i.e. >45° C.) and thereby limit the service life of the battery.

Thereby, alternative methods of cooling propulsion systems, more particularly batteries, have recently been proposed.

As such, application US 2014/0318746 describes the use of materials of high thermal conductivity at the constituent cells of a battery for electric and/or hybrid vehicles and a material with low thermal conductivity for the external casing.

Also, document US 20120161472 mentions the use of materials with low thermal conductivity in order to form the battery pack and insulate same from the outside. Said document discloses a fluid based on a water/glycol mixture with very high thermal conductivity.

Alternatively, companies have worked on the development of fluids that can be used in propulsion systems and have high thermal conductivities, particularly useful for improving the cooling of a cell and hence of the whole system.

Thereby, document WO 2015/034340 describes lubricating compositions for self-propelled applications having thermal conductivities comprised between 152 and 180 mW·m⁻¹·K⁻¹.

The inventors have sought to improve and to propose a composition having both improved cooling properties and properties of protection against thermal runaway.

### SUMMARY OF THE INVENTION

More precisely, the present invention relates to the use of a cooling composition for protecting a battery against thermal runaway, said cooling composition comprising at least one base oil and having a thermal conductivity less than or equal to 125 mW·m⁻¹·K⁻¹.

Preferentially, the battery is a lithium-ion battery.

According to one embodiment, the cooling composition used according to the invention has a thermal conductivity of less than or equal to 120 mW·m⁻¹·K⁻¹, preferentially less than or equal to 115 mW·m−1·K−1.

According to one embodiment, the cooling composition used according to the invention comprises, with respect to the total weight of the cooling composition, at least 70% by weight of base oil(s), preferentially from 70 to 99.9% by weight of base oil(s), preferentially still from 80 to 99% by weight of base oil(s), more preferentially from 85 to 98% by weight of base oil(s).

Preferentially, the cooling composition is used in a system for cooling a battery comprising at least one circulation loop wherein the cooling composition circulates.

Preferentially, the cooling composition circulates in at least one element selected from an oil pump, a fluid exchanger and an air exchanger.

Preferentially, the cooling system further comprises at least one storage tank for the cooling composition.

The invention further relates to a system for cooling a battery comprising at least one circulation loop wherein the cooling composition according to the invention circulates.

According to one embodiment of the cooling system according to the invention, the cooling composition circulates in at least one element chosen from an oil pump, a fluid exchanger and an air exchanger.

According to one embodiment, the cooling system further comprises at least one storage tank for the cooling composition.

According to one embodiment of the cooling system according to the invention, the battery is a lithium-ion battery.

The invention further relates to the use of the cooling composition according to the invention, for cooling and protecting a battery, preferentially a lithium-ion battery, against thermal runaway.

According to a preferred embodiment, the battery is used in a propulsion system of an electric or hybrid vehicle, preferentially an electric vehicle.

According to a preferred embodiment of the use according to the invention, the cooling composition is used in a cooling system as defined in the invention.

Unless otherwise indicated, the quantities in a product are expressed by weight, with respect to the total weight of the product.

### BRIEF DESCRIPTION OF DRAWINGS

FIG. 1 represents a schematic perspective view of a battery cell within the framework of the simulation of the experimental part.

FIG. 2 represents a perspective view of a battery cell and of the support (S) within the framework of the simulation of the experimental part.

FIG. 3 represents a perspective view of a box (B) comprising the cells and the support (S) within the framework of the simulation of the experimental part.

FIG. 4 represents a top view of a box B within the framework of the simulation of the experimental part.

FIG. 5 represents a perspective view of a box and of the dimensioning (D) for the calculation within the framework of the simulation of the experimental part.

FIG. 6 represents the evolution of the average temperature of the faulty cell over time, for two fluids and two durations of application of the source of heat.

FIG. 7 represents the evolution of the average temperature of the fluid over time, for two fluids and two durations of application of the source of heat.

FIG. 8 represents the evolution of the average temperature of the neighboring cell over time, for two fluids and two durations of application of the source of heat.

FIG. 9 represents the evolution of the average temperature of the faulty cell over time, for two fluids for a space of 4 mm between two cells.

FIG. 10 represents the evolution of the average temperature of the fluid over time, for two fluids for a space of 4 mm between two cells.

FIG. 11 represents the evolution of the average temperature of the neighboring cell over time, for two fluids for a space of 4 mm between two cells.

### DETAILED DESCRIPTION

The present invention relates to a composition for cooling and protecting against thermal runaway a propulsion system of an electric or hybrid vehicle, said composition comprising at least one base oil and having a thermal conductivity at 30° C. of less than or equal to 125 mW·m⁻¹·K⁻¹.

Preferentially, the cooling composition has a thermal conductivity at 30° C. less than or equal to 120 mW·m⁻¹·K⁻¹, preferentially less than or equal to 115 mW·m⁻¹·K⁻¹, more preferentially less than or equal to 110 mW·m⁻¹·K⁻¹.

The thermal conductivity is measured, e.g. according to the ASTM D7896 standard.

### Base Oil(s)

The cooling composition used according to the invention comprises one or a plurality of base oils, preferentially in a total content of at least 70% by weight, preferentially ranging from 70 to 99% by weight, more preferentially from 80 to 98% by weight, preferentially from 85 to 95% by weight, with respect to the total weight of the cooling composition.

According to one embodiment, the cooling composition comprises 100% by weight of base oil(s), with respect to the total weight of the cooling composition.

Such base oils can be chosen from base oils conventionally used in the field of lubricating oils, such as mineral oils, either synthetic or natural, animal or plant oils or mixtures thereof.

There can be a mixture of a plurality of base oils, e.g. a mixture of two, three, or four base oils.

The base oils used in the cooling compositions according to the invention can be, in particular, mineral or synthetic oils belonging to groups I to V as per the classes defined by the API classification (or the equivalents thereof as per the ATIEL classification) and shown in Table 1 hereinafter, or mixtures thereof.

TABLE 1

| | Amount of | Amount of | Viscosity |
|---|---|---|---|
| | saturates | sulfur | index (VI) |
| Group I | <90% | >0.03% | 80 ≤ VI < 120 |
| Mineral oils | | | |
| Group II | ≥90% | ≤0.03% | 80 ≤ VI < 120 |
| Hydrocracked oils | | | |
| Group III | ≥90% | ≤0.03% | ≥120 |
| Hydro-isomerized or | | | |
| hydrocracked oils | | | |

| | |
|---|---|
| Group IV | Polyalphaolefines (PAO) |
| Group V | Esters and other bases not included in groups I to IV |

The mineral base oils include any type of base oil obtained by atmospheric distillation and vacuum distillation of crude oil, followed by refining operations such as solvent extraction, deasphalting, solvent dewaxing, hydrotreatment, hydrocracking, hydroisomerization and hydrofinishing.

Mixtures of synthetic and mineral oils which can be biosourced, can be further used.

There is generally no limitation with regard to the use of different base oils for producing the compositions used according to the invention, except that the compositions have to have properties, in particular in terms of viscosity, viscosity index or resistance to oxidation, suitable for use in propulsion systems of either an electric or hybrid vehicle.

The base oils of the compositions according to the invention can be further chosen from synthetic oils, such as certain esters of carboxylic acids and alcohols, polyalphaolefins (PAO), and polyalkylene glycol (PAG) obtained by polymerization or copolymerization of alkylene oxides comprising from 2 to 8 carbon atoms, in particular from 2 to 4 carbon atoms.

The PAOs used as base oils are for example obtained from monomers comprising from 4 to 32 carbon atoms, e.g. from octene or decene. The weight-average molecular weight of the PAO can vary quite significantly. Preferentially, the weight-average molecular weight of the PAO is less than 600 Da. The weight-average molecular weight of the PAO can further range from 100 to 600 Da, from 150 to 600 Da, or further from 200 to 600 Da.

According to preferred embodiment, the base oil or oils of the composition according to the invention are chosen from polyalphaolefins (PAO), polyalkylene glycol (PAG) and esters of carboxylic acids and alcohols, silicone, ether.

### Additional Additives

Additional additives can be used in the cooling composition of the invention. The additives include antioxidants, anti-corrosion additives, anti-foaming additives and pour point depressants.

According to a particularly preferred embodiment, the cooling composition used according to the invention comprises at least one antioxidant additive.

The antioxidant additive generally makes it possible to delay the degradation of the composition in service. Such degradation most often shows in a deposit formation, in the presence of sludge or in an increase in the viscosity of the composition.

Antioxidant additives in particular act as radical inhibitors or destroyers of hydroperoxides. The antioxidant additives commonly used include phenolic antioxidants, amine antioxidant additives, phosphosulfur antioxidant additives. Some of such antioxidant additives, for example phosphosulfur antioxidant additives, can generate ashes. The phenolic antioxidant additives can be ash free or in the form of neutral or basic metal salts. The antioxidant additives can in particular be chosen from sterically hindered phenols, sterically hindered phenol esters and sterically hindered phenols comprising a thioether bridge, diphenylamines, diphenylamines substituted with at least one C1-C12 alkyl group, N,N′-dialkyl-aryl-diamines and mixtures thereof.

Preferentially, according to the invention, the sterically hindered phenols are chosen from compounds comprising a phenol group of which at least one of the carbons neighboring the carbon atom bearing the alcohol function, is substituted by at least one C₁-C₁₀ alkyl group, preferentially a C₁-C₆ alkyl group, preferentially a C₄ alkyl group, preferentially a tert-butyl group.

Amine compounds are another class of antioxidant additives which can be used, optionally in combination with phenolic antioxidant additives. Examples of amine compounds are aromatic amines, e.g. aromatic amines with the formula NR⁴R⁵R⁶ wherein R⁴ represents an aliphatic group or an optionally substituted aromatic group, R⁵ represents an optionally substituted aromatic group, R⁶ represents a hydrogen atom, an alkyl group, an aryl group or a group with the formula R⁷S(O)_{z}R⁸ wherein R⁷ represents an alkylene or an alkenylene group, R⁸ represents an alkyl group, an alkenyl group or an aryl group and z is 0, 1 or 2.

Sulfur alkyl phenols or the alkali or alkaline-earth metal salts thereof can be further used as antioxidant additives.

Another class of antioxidant additives is the class of copper compounds, e.g. copper thio- or dithio-phosphate, copper salts and carboxylic acid salts, copper dithiocarbamates, copper sulfonates, copper phenates, copper acetylacetonates. Copper salts I and II, succinic acid salts or succinic anhydride salts can also be used.

A cooling composition used according to the invention can further contain any type of antioxidant known to a person skilled in the art.

The cooling composition used according to the invention can comprise 0.1 to 2% by weight of at least one antioxidant additive, with respect to the total weight of the composition.

According to a particular embodiment, the cooling composition used according to the invention is free from antioxidant additives of aromatic amine type or of sterically hindered phenol type.

The cooling composition used according to the invention can comprise at least one anti-corrosion additive.

The anti-corrosion additive advantageously delays or prevents the corrosion of the metal parts of the battery.

A cooling composition used according to the invention can comprise from 0.01 to 2% by weight or from 0.01 to 5% by weight, preferentially from 0.1 to 1.5% by weight or from 0.1 to 2% by weight of anti-corrosion agent, with respect to the total weight of the composition.

The cooling composition used according to the invention can further comprise at least one anti-foaming agent.

The anti-foaming agent can be chosen from polyacrylates or further waxes.

The cooling composition used according to the invention can comprise from 0.01 to 2% by weight or from 0.01 to 5% by weight, preferentially from 0.1 to 1.5% by weight or from 0.1 to 2% by weight of anti-foaming agent, with respect to the total weight of the composition.

The cooling composition used according to the invention can further comprise at least one pour point depressant (PPD) additive.

By slowing down the formation of paraffin crystals, the pour point depressant additives generally improve the behavior of the composition under cold conditions. Examples of pour point depressant additives include alkyl polymethacrylates, polyacrylates, polyarylamides, polyalkylphenols, polyalkylnaphthalene, alkyls polystyrenes.

When the cooling composition is used in a lubrication system, the cooling composition used according to the invention can further also comprise any type of additive suitable for being used in a lubricant for the propulsion system of an electric or hybrid vehicle and can be called a lubricating composition.

Such additives, known to a person skilled in the art in the field of the lubrication of propulsion systems for electric or hybrid vehicles can be chosen from friction modifiers, detergents, anti-wear additives, extreme pressure additives, dispersants, and mixtures thereof.

A lubricating composition used according to the invention can comprise at least one friction modifier additive. The friction modifier additive can be chosen from a compound providing metallic elements and an ashless compound. Compounds providing metal elements include complexes of transition metals such as Mo, Sb, Sn, Fe, Cu, Zn, the ligands of which can be hydrocarbon compounds comprising oxygen, nitrogen, sulfur or phosphorus atoms. Ashless friction modifier additives are generally of organic origin and can be chosen from fatty acid and polyol monoesters, alkoxylated amines, alkoxylated fatty amines, fatty epoxides, fatty epoxide borates, fatty amines acid or fatty acid glycerol esters. According to the invention, fatty compounds comprise at least one hydrocarbon moiety comprising from 10 to 24 carbon atoms.

The lubricating composition used according to the invention can comprise from 0.01 to 2% by weight or from 0.01 to 5% by weight, preferentially from 0.1 to 1.5% by weight or from 0.1 to 2% by weight of friction modifier additive, with respect to the total weight of the composition.

The lubricating composition used according to the invention can further comprise at least one detergent additive.

Detergent additives generally reduce the formation of deposits on the surface of metal parts, by dissolving oxidation and combustion by-products.

The detergent additives which can be used in the lubricating compositions used according to the invention are generally known to a person skilled in the art. The detergent additives can be anionic compounds comprising a long lipophilic hydrocarbon chain and a hydrophilic head. The associated cation can be a metal cation of an alkali or alkaline earth metal.

Detergent additives are preferentially chosen from alkali metal salts or alkaline-earth metal salts of carboxylic acid, sulfuonates, salicylates, naphthenates, as well as phenate salts. The alkali metals and alkaline earth metals are preferentially calcium, magnesium, sodium or barium.

Such metal salts generally include the metal in a stoichiometric amount or in an excess amount, i.e. in a concentration greater than the stoichiometric amount. Same are then overbased detergents; the metal in excess which gives the overbased character to the detergent additive is generally in the form of an oil-insoluble metal salt, e.g. a carbonate, a hydroxide, an oxalate, an acetate, a glutamate, preferentially a carbonate.

The lubricating composition used according to the invention can comprise from 2 to 4% by weight of detergent additive, with respect to the total weight of the composition.

Also, the lubricating composition used according to the invention can comprise at least one dispersing agent.

The dispersing agent can be chosen from Mannich bases, succinimides, e.g. polyisobutylene succinimides.

The lubricating composition used according to the invention can comprise from 0.2 to 10% by weight of dispersing agent(s) with respect to the total weight of the composition.

The lubricating composition used according to the invention can further comprise at least one anti-wear and/or extreme pressure agent.

There is a wide variety of anti-wear additives. Preferentially, for the lubricating composition according to the invention, the anti-wear additives are chosen from phosphorus-sulfur additives such as metal alkylthiophosphates, in particular zinc alkylthiophosphates, and more specifically zinc dialkyldithiophosphates or ZnDTP. Preferred compounds have the formula Zn((SP(S)(OR²)(OR³))₂, wherein R² et R³—either identical or different—independently represent an alkyl group, preferentially an alkyl group including from 1 to 18 carbon atoms.

Amine phosphates as well are anti-wear additives which can be used in the lubricating compositions according to the invention. However, the phosphorus provided by such additives can act as a poison in the catalytic systems of cars since they can generate ash. Such effects can be minimized by partially substituting the amine phosphates with additives which do not bring phosphorous, such as e.g. polysulfides, in particular sulfur-containing olefins.

The lubricating composition used according to the invention can comprise from 0.01 to 15%, preferentially 0.1 to 10% by weight, preferentially 1 to 5% by weight of anti-wear agent(s), with respect to the total weight of the composition.

The lubricating composition used according to the invention can comprise at least one additive improving the antioxidant viscosity index (VI improver). Examples of VI improvers include polymethacrylates, polyisobutenes or fatty acid esters. When present, such additives can represent from 1 to 25% by weight of the total weight of the lubricating composition.

Advantageously, a composition suitable for the invention comprises at least one additional additive chosen from friction modifiers, viscosity index modifiers, detergents, extreme-pressure additives, dispersants, antioxidants, anti-corrosion additives, pour point depressants, anti-foaming agents and mixtures thereof.

Preferentially, the cooling composition used in the invention comprises less than 0.01% by weight of halocarbon compound(s), preferentially the cooling composition used in the invention is free of halocarbon compound(s).

Such additives can be introduced separately and/or as a mixture similar to the additives already available for sale for commercial lubricant formulations for vehicle engines, with a performance level as defined by the ACEA (European Automobile Manufacturers Association) and/or the API (American Petroleum Institute), well known to a person skilled in the art.

In terms of the formulation of such composition, said additional additive(s) can be added to an oil or to mixture of base oils.

Advantageously, the cooling composition according to the invention has a kinematic viscosity, measured at 40° C. as per the standard ASTM D445, ranging from 1.5 to 35 mm²/s, more particularly from 2 to 25 mm²/s, even from 2.5 to 10 mm²/s.

Advantageously, the cooling composition used according to the invention has a kinematic viscosity, measured at 100° C. as per the standard ASTM D445, ranging from 0.5 to 7 mm²/s, more particularly from 1 to 4 mm²/s, even from 1.5 to 2.5 mm²/s.

The cooling composition according to the invention can be used for cooling the cells of a battery, more particularly a lithium-ion battery. The battery, more particularly a lithium-ion battery, can be used in a propulsion system of an electric or hybrid vehicle, more particularly an electric vehicle.

The cooling composition used according to the invention makes it possible to limit or even eliminate the propagation of a thermal runaway when the composition is used in a battery, more particularly a lithium-ion battery. More particularly, the battery can be used in a propulsion system of an electric or hybrid vehicle, more particularly an electric vehicle.

Thereby, the composition according to the invention can be used for cooling and/or protecting a battery, more particularly a lithium-ion battery, against the propagation of a thermal runaway. More particularly, the battery can be used in a propulsion system of an electric or hybrid vehicle, more particularly an electric vehicle.

Typically, the cooling composition is used at temperatures ranging from −40° C. to +70° C., preferentially at temperatures ranging from 0 to 30° C.

According to the invention, the particular, advantageous or preferred features of the composition according to the invention make it possible to define uses according to the invention which are also particular, advantageous or preferred.

The cooling composition according to the invention can typically circulate in a circulation loop of a cooling system of a propulsion system of an electric or hybrid vehicle, more particularly of an electric vehicle.

According to a preferred embodiment, the cooling composition according to the invention will be used for cooling and/or protecting against the propagation of a thermal runaway the battery of the propulsion system of an electric or hybrid vehicle, more particularly of an electric vehicle.

Generally, in the case of a battery including a plurality of cells, a thermal runaway can be characterized by the damage to a cell (the cell will then be called “faulty”) which results in an increase in the internal temperature thereof which will produce exothermic reactions within the electrolyte, which could lead to an ejection of gas and a discharge of energy, in the form of heat, from the chemical reactions thereof.

The thermal runaway of an isolated cell often results in a propagation of the runaway to the neighboring cell. Indeed, an increase in the temperature of a cell, reaching a temperature of at least 90° C. or even at least 100° C. or even at least 120° C. also initiates a thermal runaway.

Typically, a cell will be called faulty when the temperature thereof rises beyond 100° C., or even beyond 120° C. The increase in heat can sometimes be accompanied by an ejection of gas.

The cooling composition according to the invention can thus be used in a circulation loop of a cooling system of a battery.

The batteries of the invention, preferentially lithium-ion batteries, can be used at temperatures ranging from −40° C. to +70° C., preferentially from 0 to 30° C.

In the event of runaway, the faulty battery cell can reach temperatures on the order of 400 to 800° C.

The present invention further relates to a system for cooling a battery, more particularly a lithium-ion battery. According to a preferred embodiment, the battery is used in a propulsion system of an electric or hybrid vehicle.

The cooling system according to the invention comprises at least one circulation loop wherein the cooling composition according to the invention circulates.

Typically, the cooling system comprises at least one element chosen from an oil pump, a fluid exchanger (heat exchanger between two fluids, also called a “chiller”) and a heat pump. Thereby, according to one embodiment, the cooling composition according to the invention circulates in at least one element chosen from an oil pump, a chiller and an air exchanger, preferentially in all the elements chosen from an oil pump, a chiller and an air exchanger.

As defined by the present invention, the heat pump can be considered as a heating system or as a refrigeration system.

Generally, the cooling system further comprises a storage tank for the cooling composition.

The cooling system will preferentially be used at temperatures ranging from −40° C. to +70° C. under normal conditions, or even from 0 to +30° C.

The cooling system according to the invention will make it possible to limit or even prevent thermal runaway in a battery, such as a lithium-ion battery, which can be used in a propulsion system of an electric or hybrid vehicle, preferentially an electric vehicle.

The invention further relates to the use of the cooling composition according to the invention for cooling and/or for protecting against thermal runaway, a battery, such as a lithium-ion battery, e.g. used in a propulsion system of an electric or hybrid vehicle, preferentially an electric vehicle, in a cooling system according to the invention.

The invention further relates, according to another of the aspects thereof, to a method for cooling a battery, preferentially a lithium-ion battery, comprising at least one heat exchange step between the cooling composition according to the invention and at least one part of said battery. Typically, the cooling process comprises at least one step wherein one part of said battery is cooled by means of the heat exchange step. Preferentially, the method is used at least in the battery of a propulsion system of an electric or hybrid vehicle, preferentially an electric vehicle.

Furthermore, according to a preferred embodiment, the method for cooling a battery, preferentially a lithium-ion battery, does not use halocarbon compounds.

More specifically, the method for cooling a battery according to the invention uses a single cooling composition, preferentially comprising at least 70% by weight of base oil(s), preferentially from 70 to 100% by weight of base oil(s), with respect to the total weight of the cooling composition.

The invention further relates to a method for protecting a battery, such as a lithium-ion battery, against thermal runaway, comprising at least one step of heat exchange between the cooling composition according to the invention and at least one part of said battery. Preferentially, the method of protection against thermal runaway is used in the battery of a propulsion system of an electric or hybrid vehicle, preferentially an electric vehicle. Typically, the protection method according to the invention is used in a battery including a plurality of cells and the method comprises at least one step of runaway of a cell and one step wherein the temperature of the neighboring cell does not exceed 120° C., preferentially does not exceed 100° C. or even does not exceed 90° C.

Preferentially, the methods are used in the cooling system according to the invention.

Furthermore, according to a preferred embodiment, the method for protecting a battery against thermal runaway, preferentially a lithium-ion battery, does not use halocarbon fluid(s).

More specifically, the method of protecting a battery against thermal runaway according to the invention uses a single cooling composition, preferentially comprising at least 70% by weight of base oil(s), preferentially from 70 to 100% by weight of base oil(s), with respect to the total weight of the cooling composition.

All the features and preferences described for the cooling composition according to the invention and for the uses thereof, also apply to said method.

The invention will now be described by means of the following examples, given of course as an illustration of the invention, but not limited to.

### Examples

A thermal runaway in an electric vehicle battery was simulated using the simulation software: COMSOL MULTIPHYSICS® 5.4, based on the finite element method.

The modeled battery comprises 5 cells, each identical and with rectangular parallelepiped shape, not deformable, of dimensions:
Length L (dimension x)=250 mm,
width 1 (dimension z)=198 mm and
thickness e (dimension y)=5 mm.

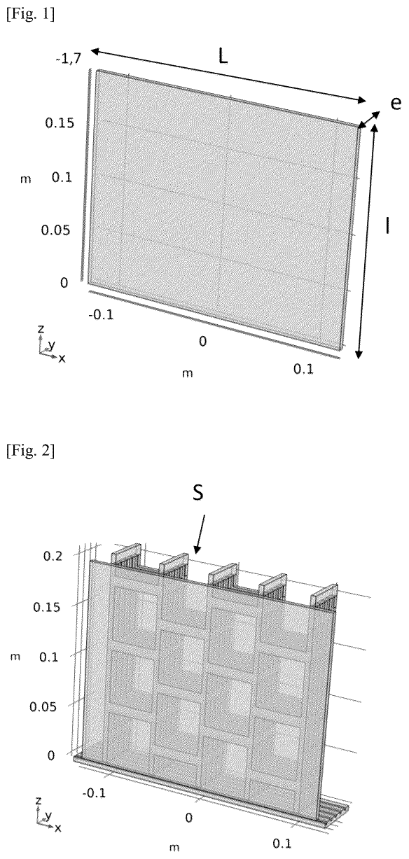

FIG. 1 represents a view of a cell.

The properties of the cells are as follows:
Density (density): rho=2700 kg/m³
Specific heat capacity: CP=900 J/(kg·K);
Anisotropic thermal conductivity: kxx=kzz=35 W/(m·K), kyy=0.8 W/(m·K).

A volumetric heat source is applied to the first cell (the cell undergoing thermal runaway). Such source has been calculated for raising the temperature of the faulty cell to about 800° C. (starting from a temperature of 30° C.) within 10 s. The calculation used is as follows: Q=rho*CP*difference in temperature/duration of the runaway. A constant value of source of heat value of 1.8711e8 W/m³ results therefrom.

Said value was kept in the case where the runaway lasts 15 s, the faulty cell thus receiving in such case more energy than in the case where the runaway lasts 10 s (factor 1.5).

In such tests, the effect of thermal conductivity was evaluated. Thereby, only said parameter was modified from one fluid (cooling composition) to another, using the behavior law:
For the fluid having a thermal conductivity of 110 W/(m·K), the following is used:

$$k = - 0.2 {1}^{*} T + 116.35$$

For the fluid having a thermal conductivity of 140 W/(m·K), the following is used:

$$k = - 0.2 {1}^{*} T + 146.35$$

The properties of the cell support were chosen so as to represent a copolyester:
Density: Rho=1130 kg/m³
Specific heat capacity: CP=1600 J/(kg·K);
Isotropic thermal conductivity: k=0.19 W/(m·K).

FIG. 2 shows a view of the support (S).

The box has the following external dimensions:
L=274 mm;
1=231 mm
e=64 mm.

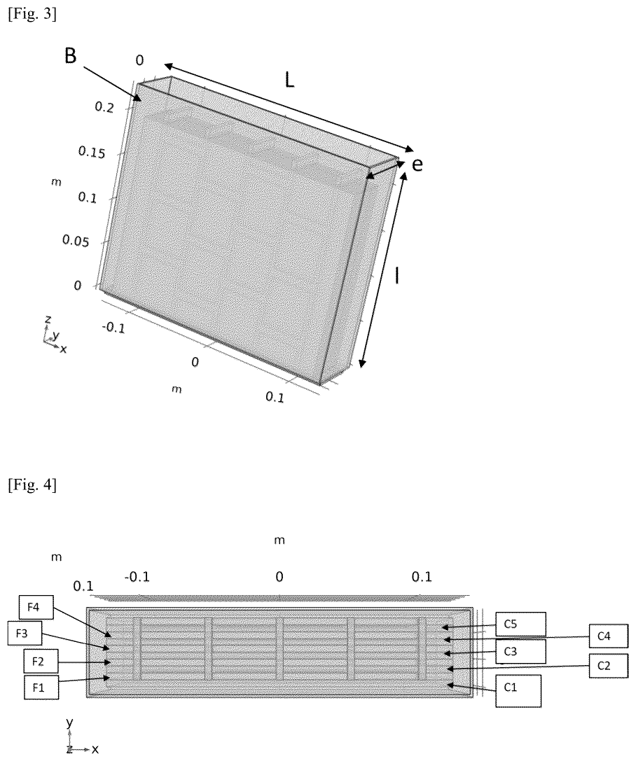

FIG. 3 shows a view of the box (B) enclosing the cells and the support.

The walls of the box have a thickness of 2 mm.

The properties thereof correspond to steel and are as follows:
Density: Rho=7850 kg/m 3
Specific heat capacity: CP=475 J/(kg·K);
Isotropic thermal conductivity: k=44.5 W/(m·K).

FIG. 4 is a top view of a box comprising:
5 cells: C1, C2, C3, C4 and C5
4 spaces filled with a fluid: F1, F2, F3, F4, between each cell.

For the simulation tests, the cell C1 has been made faulty (by application of the source of heat).

In order to limit the size of the problem to be solved, the geometry of the simulation model has been reduced to the left-hand part of the complete geometry. A symmetry condition has been applied at the section plane. As a result, the geometry actually simulated differs from the complete geometry. Nevertheless, the source of heat being applied in a volumetric way and the box being closed (no fluid inlet or outlet), such simplification has no qualitative influence on the simulated phenomena and on the conclusions drawn from the study. The section plane is positioned at a distance of 111.375 mm from the left-hand end of the box, positioning same exactly in the middle of the second portion of the support.

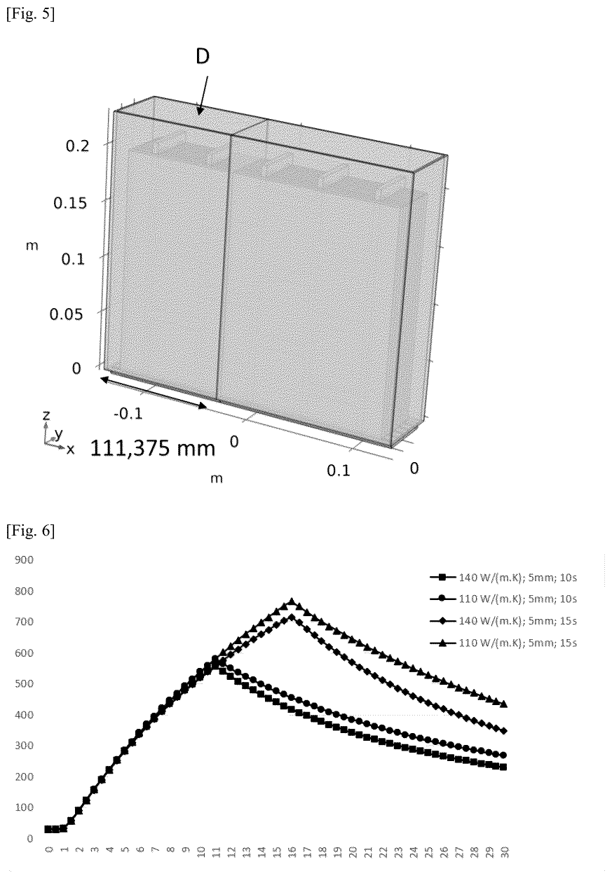

FIG. 5 shows the sizing (D) for the calculation. The volume of fluid used in the domain (D) is 0.936 liters.

The physical modeling is characterized by the following elements:
The strong coupling (i.e. flow influences heat transfers via the advection term and thermal conditions influence flow through the dependence of fluid properties on temperature) between the Navier-Stokes equations describing the flow and the heat equation representing the heat transfers in the fluid.
The heat equation in all solids so as to represent heat transfers in solids.
The fluid is considered incompressible (only the influence of the thermal conditions on the density is taken into account, which is the Boussinesq approximation).
The thermal runaway of the first cell is modeled by the source of heat described hereinabove.
the system operates in a closed circuit, the fluid circulates only by the effect of the change in density with temperature.
the number of meshes used for the discretization of the model is: 1,377,265 meshes for the fluid, 2,392,214 meshes for the cells, 71,127 meshes for the box, 1,324,894 meshes for the support.

In such tests, a non-slip condition is applied to the fluid on each surface where the fluid is in contact with a solid (cells or box). On the other hand, the upper surface of the fluid domain is a free surface on which tangential velocities are allowed. From a thermal point of view, the free surface of the fluid and all the external surfaces of the box (except the lower surface) exchange heat with the external air (which is at 30° C.) with an exchange coefficient h=10 W/(m²·K). The box being placed on a support, it is considered that there is no heat exchange between the fluid and the bottom part of the box.

FIGS. 6, FIG. 7 and FIG. 8 represent, respectively, the mean temperature of the faulty cell (C1), the mean temperature of the fluid, the mean temperature of the neighboring cell (C2), for two fluids which are distinguished only by the thermal conductivity, and for two different durations of application of the source of heat, 10 seconds and 15 seconds. For the results illustrated in the 3 figures, the cells are separated by a space of 5 mm.

FIG. 6 shows that a duration of 15 seconds will cause a greater increase in the temperature of the faulty cell, making it possible to simulate a more severe case of thermal runaway.

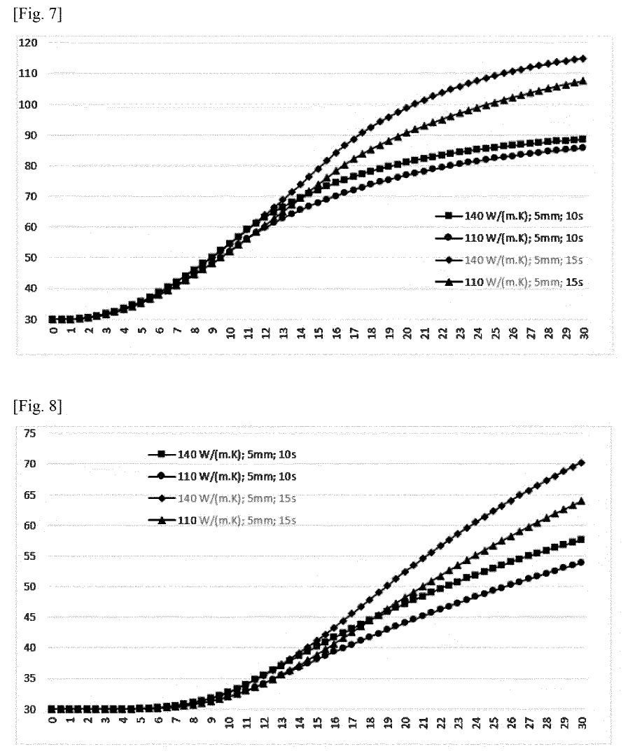

As shown by the results of FIG. 7, the mean temperature of the fluid is lower in the case where the cooling composition according to the invention is used.

As shown by the results of FIG. 8, the mean temperature of the neighboring cell is lower when the cooling composition according to the invention is used. Thereby, the cooling composition according to the invention makes it possible, at a minimum, to limit, but above all to prevent, the propagation of thermal runaway.

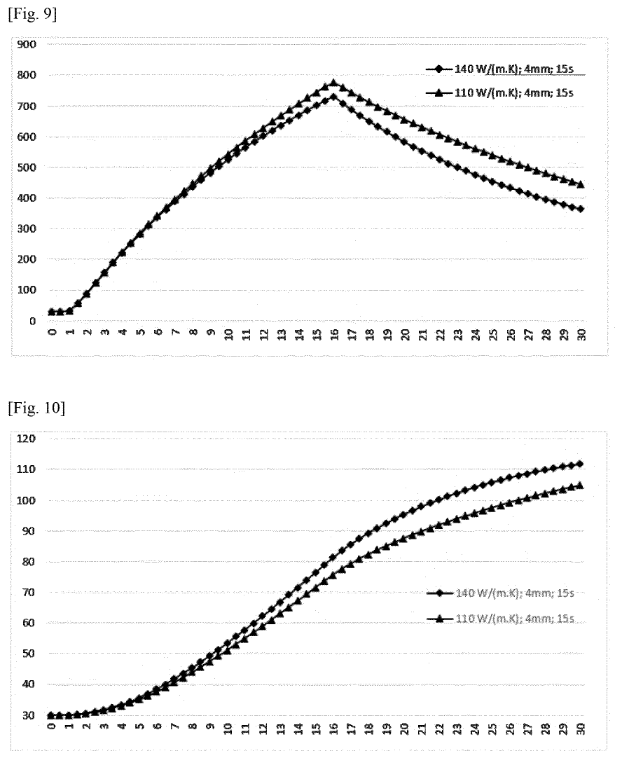

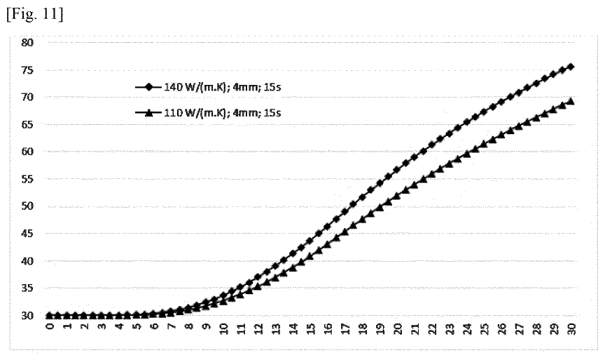

Other tests were carried out but this time with a space of 4 mm between two cells and a duration of 15 s. A smaller spacing between two cells is more conducive for the propagation of a thermal runaway. The results are illustrated in FIGS. 9 (mean temperature of the faulty cell), FIG. 10 (mean temperature of the fluid) and FIG. 11 (mean temperature of the neighboring cell). The results of FIG. 10 and FIG. 11 show the effect of the cooling composition according to the invention in cooling and limiting and preventing the propagation of thermal runaway even under more severe conditions, namely 4 mm spacing and higher heating of the faulty cell.

1.-10. (canceled)

11. A method for protecting a battery against thermal runaway, comprising at least one step of heat exchange between a cooling composition and at least one part of the battery, the cooling composition comprising at least one base oil and having a thermal conductivity less than or equal to 125 mW·m−1·K−1.

12. The method according to claim 10, wherein the cooling composition has a thermal conductivity of less than or equal to 120 mW·m−1·K−1.

13. The method according to claim 10, wherein the cooling composition comprises, with respect to the total weight of the cooling composition, at least 70% by weight of base oil(s).

14. The method according to claim 10, wherein the cooling composition comprises 100% by weight of base oil(s), with respect to the total weight of the cooling composition.

15. The method according to claim 10, wherein the cooling composition is used in a cooling system of a battery comprising at least one circulation loop wherein the cooling composition circulates.

16. The method according to claim 15, wherein the cooling composition circulates in at least one element chosen from an oil pump, a fluid exchanger and an air exchanger.

17. The method according to claim 15, wherein the cooling system further comprises at least one storage tank for the cooling composition.

18. The method according to claim 10, wherein the battery is a lithium-ion battery.

19. The method according to claim 10, comprising a step of cooling the battery by means of the heat exchange step.

20. The method according to claim 10, wherein the battery is used in a propulsion system of an electric or hybrid vehicle.

21. The method according to claim 10, wherein the cooling composition has a thermal conductivity of less than or equal to 115 mW·m−1·K−1.

22. The method according to claim 10, wherein the cooling composition comprises, with respect to the total weight of the cooling composition, from 70 to 99.9% by weight of base oil(s).

23. The method according to claim 10, wherein the cooling composition comprises, with respect to the total weight of the cooling composition, from 80 to 99% by weight of base oil(s).

24. The method according to claim 10, wherein the cooling composition comprises, with respect to the total weight of the cooling composition, from 85 to 98% by weight of base oil(s).

25. The method according to claim 10, wherein the battery is used in a propulsion system of an electric vehicle.

26. The method according to claim 10, wherein the battery comprises a plurality of cells and the method comprises at least one step of runaway of a cell and one step wherein the temperature of the neighboring cell does not exceed 120° C.
